(19) United States
(12) Patent Application Publication
(10) Pub. No.: US 2025/0007753 A1
(43) Pub. Date: Jan. 2, 2025

(54) TECHNIQUES FOR SUPPORTING UNTAGGED ETHERNET FRAMES

(71) Applicant: QUALCOMM INCORPORATED, San Diego, CA (US)

(72) Inventors: Sebastian Speicher, Wallisellen (CH); Huichun Liu, San Diego, CA (US)

(21) Appl. No.: 18/709,468

(22) PCT Filed: Jan. 26, 2022
(86) PCT No.: PCT/CN2022/073921

§ 371 Date: May 10, 2024

(51) Int. Cl. H04L 12/46

(52) U.S. Cl. CPC H04L 12/4645

(57) ABSTRACT

Methods, systems, and devices for wireless communications are described. A wireless communications system may support Ethernet frames that exclude a virtual local area network (VLAN) tag. A first device may receive a frame excluding a VLAN tag, and the first device may forward the frame to a second device. The second device may determine priority information (e.g., a default traffic class, a default frame priority) for the frame. In other examples, the first device may add a data tag (e.g., metadata indicating the priority information) to the frame. The first device may forward the frame to the second device, and the second device may remove the data tag from the frame. In either case, the second device may classify the frame according to a traffic class associated with a respective queue based on the priority information and may transmit the frame based on the traffic class and the respective queue.

### CROSS REFERENCE

The present application is a 371 national stage filing of International PCT Application No. PCT/CN2022/073921 by Speicher et al. entitled “TECHNIQUES FOR SUPPORTING UNTAGGED ETHERNET FRAMES,” filed Jan. 26, 2022, which is assigned to the assignee hereof, and which is expressly incorporated by reference in its entirety herein.

### FIELD OF TECHNOLOGY

The following relates to wireless communications, including techniques for supporting untagged Ethernet frames.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses for supporting untagged Ethernet frames. Generally, the described techniques provide for assigning a default frame priority or a default traffic class to untagged Ethernet frames. For example, a first device may receive an Ethernet frame excluding a virtual local area network (VLAN) tag (e.g., an untagged Ethernet frame) from a network and forward the untagged Ethernet frame to a second device. Prior to transmission, the second device may classify the untagged Ethernet frame according to a traffic class associated with a respective queue, where the frame may be classified based on the frame excluding the VLAN tag. In some cases, the second device may classify the untagged Ethernet frame based on priority information determined by the second device. For example, the second device may receive signaling from a network entity indicating the priority information or the priority information may be preconfigured. In some cases, the priority information may include a default traffic class and the second device may classify the untagged Ethernet frame based on the default traffic class. In some other cases, the priority information may include a default frame priority, and the second device may apply the default frame priority to the untagged Ethernet frame and select a traffic class associated with the default frame priority based on a mapping table. The second device may then classify the untagged Ethernet frame based on the selected traffic class associated with the default frame priority. In any case, the second device may transmit the untagged Ethernet frame according to the traffic class and the respective queue.

Additionally, or alternatively, the first device may receive an untagged Ethernet frame from the network and may add a data tag (e.g., an internal data tag) indicating priority information for the untagged Ethernet frame. The first device may forward the untagged Ethernet frame, including the data tag, to the second device. In some cases, the data tag may include a VLAN identifier and a priority value. In some other cases, the data tag may include metadata indicating a priority value for the untagged Ethernet frame. The second device may receive the untagged Ethernet frame, including the data tag, and may remove the data tag upon classifying the untagged Ethernet frame and based on the priority information indicated by the data tag. As an example, the second device may classify the untagged Ethernet frame according to a traffic class associated with a respective queue based on the priority information indicated by the data tag, and the second device may apply the priority value to the untagged Ethernet frame and may select a traffic class associated with the priority value based on a mapping table. The second device may transmit the untagged Ethernet frame according to the traffic class and respective queue.

A method for wireless communications is described. The method may include receiving, at a first device, one or more frames from a second device, the one or more frames being associated with an Ethernet-type protocol data unit session, where a first frame of the one or more frames excludes a virtual local area network tag, classifying each frame of the one or more frames according to a set of multiple traffic classes that are each associated with a respective queue, where the first frame is classified into a traffic class based on the first frame excluding the virtual local area network tag, and transmitting, from the first device, the one or more frames based on the set of multiple traffic classes and the respective queues.

An apparatus for wireless communications is described. The apparatus may include a processor, memory coupled with the processor, and instructions stored in the memory. The instructions may be executable by the processor to cause the apparatus to receive, at a first device, one or more frames from a second device, the one or more frames being associated with an Ethernet-type protocol data unit session, where a first frame of the one or more frames excludes a virtual local area network tag, classify each frame of the one or more frames according to a set of multiple traffic classes that are each associated with a respective queue, where the first frame is classified into a traffic class based on the first frame excluding the virtual local area network tag, and transmit, from the first device, the one or more frames based on the set of multiple traffic classes and the respective queues.

Another apparatus for wireless communications is described. The apparatus may include means for receiving, at a first device, one or more frames from a second device, the one or more frames being associated with an Ethernet-type protocol data unit session, where a first frame of the one or more frames excludes a virtual local area network tag, means for classifying each frame of the one or more frames according to a set of multiple traffic classes that are each associated with a respective queue, where the first frame is classified into a traffic class based on the first frame excluding the virtual local area network tag, and means for transmitting, from the first device, the one or more frames based on the set of multiple traffic classes and the respective queues.

A non-transitory computer-readable medium storing code for wireless communications is described. The code may include instructions executable by a processor to receive, at a first device, one or more frames from a second device, the one or more frames being associated with an Ethernet-type protocol data unit session, where a first frame of the one or more frames excludes a virtual local area network tag, classify each frame of the one or more frames according to a set of multiple traffic classes that are each associated with a respective queue, where the first frame is classified into a traffic class based on the first frame excluding the virtual local area network tag, and transmit, from the first device, the one or more frames based on the set of multiple traffic classes and the respective queues.

Some examples of the method, apparatuses, and non-transitory computer-readable medium described herein may further include operations, features, means, or instructions for determining priority information for frames excluding the virtual local area network tag, where the first frame may be classified based on the priority information.

In some examples of the method, apparatuses, and non-transitory computer-readable medium described herein, the priority information includes a default frame priority for frames excluding the virtual local area network tag and the method, apparatuses, and non-transitory computer-readable medium may include further operations, features, means, or instructions for applying the default frame priority to the first frame and selecting the traffic class that corresponds to the default frame priority based on a mapping table, where the first frame may be classified into the traffic class based on the default frame priority.

In some examples of the method, apparatuses, and non-transitory computer-readable medium described herein, the priority information includes a default traffic class for frames excluding the virtual local area network tag and the first frame may be classified based on the default traffic class.

Some examples of the method, apparatuses, and non-transitory computer-readable medium described herein may further include operations, features, means, or instructions for receiving, from a network entity, signaling indicating the priority information, where the priority information may be determined based on the signaling.

In some examples of the method, apparatuses, and non-transitory computer-readable medium described herein, the signaling may be received via at least one of a port management information container or a bridge management information container.

In some examples of the method, apparatuses, and non-transitory computer-readable medium described herein, the network entity includes a session management function, a policy control function, a time-sensitive networking application function, or a time-sensitive communication and time synchronization function.

In some examples of the method, apparatuses, and non-transitory computer-readable medium described herein, the priority information includes a default frame priority for frames excluding the virtual local area network tag, the default frame priority being preconfigured at the first device and the first frame may be classified based on the default frame priority and a mapping table.

In some examples of the method, apparatuses, and non-transitory computer-readable medium described herein, the priority information includes a default traffic class for frames excluding the virtual local area network tag, the default traffic class being preconfigured at the first device and the first frame may be classified based on the default traffic class.

In some examples of the method, apparatuses, and non-transitory computer-readable medium described herein, the first frame excluding the virtual local area network tag may be associated with a generic precision time protocol.

In some examples of the method, apparatuses, and non-transitory computer-readable medium described herein, the first device includes a user equipment (UE) and the second device may be associated with a network entity.

In some examples of the method, apparatuses, and non-transitory computer-readable medium described herein, the first device may be associated with a network entity and the second device includes a UE.

A method is described. The method may include receiving, at a first device, one or more frames from a network, the one or more frames being associated with an Ethernet-type protocol data unit session, where a first frame of the one or more frames excludes a virtual local area network tag, adding, to the first frame, a data tag indicating priority information for the first frame based on the first frame excluding the virtual local area network tag, and forwarding, to a second device, the one or more frames including the first frame and the data tag.

An apparatus is described. The apparatus may include a processor, memory coupled with the processor, and instructions stored in the memory. The instructions may be executable by the processor to cause the apparatus to receive, at a first device, one or more frames from a network, the one or more frames being associated with an Ethernet-type protocol data unit session, where a first frame of the one or more frames excludes a virtual local area network tag, add, to the first frame, a data tag indicating priority information for the first frame based on the first frame excluding the virtual local area network tag, and forward, to a second device, the one or more frames including the first frame and the data tag.

Another apparatus is described. The apparatus may include means for receiving, at a first device, one or more frames from a network, the one or more frames being associated with an Ethernet-type protocol data unit session, where a first frame of the one or more frames excludes a virtual local area network tag, means for adding, to the first frame, a data tag indicating priority information for the first frame based on the first frame excluding the virtual local area network tag, and means for forwarding, to a second device, the one or more frames including the first frame and the data tag.

A non-transitory computer-readable medium storing code is described. The code may include instructions executable by a processor to receive, at a first device, one or more frames from a network, the one or more frames being associated with an Ethernet-type protocol data unit session, where a first frame of the one or more frames excludes a virtual local area network tag, add, to the first frame, a data tag indicating priority information for the first frame based on the first frame excluding the virtual local area network tag, and forward, to a second device, the one or more frames including the first frame and the data tag.

Some examples of the method, apparatuses, and non-transitory computer-readable medium described herein may further include operations, features, means, or instructions for determining the priority information for the first frame based on the first frame excluding the virtual local area network tag.

Some examples of the method, apparatuses, and non-transitory computer-readable medium described herein may further include operations, features, means, or instructions for receiving, from a network entity, signaling indicating the priority information for the first frame, where determining the priority information may be based on the signaling.

Some examples of the method, apparatuses, and non-transitory computer-readable medium described herein may further include operations, features, means, or instructions for assigning default virtual local area network information to the first frame based on the signaling and the first frame excluding the virtual local area network tag, where the priority information includes an indication of the default virtual local area network information.

In some examples of the method, apparatuses, and non-transitory computer-readable medium described herein, the default virtual local area network information includes a virtual local area network identifier value and a priority value and the data tag may be based on the virtual local area network identifier value and the priority value.

In some examples of the method, apparatuses, and non-transitory computer-readable medium described herein, the signaling may be received via at least one of a port management information container or a bridge management information container.

In some examples of the method, apparatuses, and non-transitory computer-readable medium described herein, the data tag includes a virtual local area network identifier or a frame priority, or both.

In some examples of the method, apparatuses, and non-transitory computer-readable medium described herein, the data tag includes metadata associated with the first frame, the metadata indicating a priority of the first frame.

In some examples of the method, apparatuses, and non-transitory computer-readable medium described herein, the priority information includes a default frame priority for frames excluding the virtual local area network tag.

In some examples of the method, apparatuses, and non-transitory computer-readable medium described herein, the first frame excluding the virtual local area network tag may be associated with a generic precision time protocol.

A method is described. The method may include receiving, at a second device, one or more frames from a first device, where a first frame of the one or more frames includes a data tag that indicates priority information for the first frame, removing the data tag from the first frame, classifying each frame of the one or more frames according to a set of multiple traffic classes that are each associated with a respective queue, where the first frame is classified into a traffic class based on the priority information indicated by the data tag, and transmitting, from the second device, the one or more frames based on the set of multiple traffic classes and the respective queues.

An apparatus is described. The apparatus may include a processor, memory coupled with the processor, and instructions stored in the memory. The instructions may be executable by the processor to cause the apparatus to receive, at a second device, one or more frames from a first device, where a first frame of the one or more frames includes a data tag that indicates priority information for the first frame, remove the data tag from the first frame, classify each frame of the one or more frames according to a set of multiple traffic classes that are each associated with a respective queue, where the first frame is classified into a traffic class based on the priority information indicated by the data tag, and transmit, from the second device, the one or more frames based on the set of multiple traffic classes and the respective queues.

Another apparatus is described. The apparatus may include means for receiving, at a second device, one or more frames from a first device, where a first frame of the one or more frames includes a data tag that indicates priority information for the first frame, means for removing the data tag from the first frame, means for classifying each frame of the one or more frames according to a set of multiple traffic classes that are each associated with a respective queue, where the first frame is classified into a traffic class based on the priority information indicated by the data tag, and means for transmitting, from the second device, the one or more frames based on the set of multiple traffic classes and the respective queues.

A non-transitory computer-readable medium storing code is described. The code may include instructions executable by a processor to receive, at a second device, one or more frames from a first device, where a first frame of the one or more frames includes a data tag that indicates priority information for the first frame, remove the data tag from the first frame, classify each frame of the one or more frames according to a set of multiple traffic classes that are each associated with a respective queue, where the first frame is classified into a traffic class based on the priority information indicated by the data tag, and transmit, from the second device, the one or more frames based on the set of multiple traffic classes and the respective queues.

Some examples of the method, apparatuses, and non-transitory computer-readable medium described herein may further include operations, features, means, or instructions for receiving, from a network entity, signaling including information associated with the data tag, where the data tag may be removed based on the information associated with the data tag.

In some examples of the method, apparatuses, and non-transitory computer-readable medium described herein, the information associated with the data tag includes a virtual local area network identifier.

In some examples of the method, apparatuses, and non-transitory computer-readable medium described herein, the data tag includes a virtual local area network identifier and a default frame priority based on the priority information.

In some examples of the method, apparatuses, and non-transitory computer-readable medium described herein, the data tag includes metadata associated with the first frame and the first frame may be classified based on the metadata.

In some examples of the method, apparatuses, and non-transitory computer-readable medium described herein, the priority information includes a default frame priority and the method, apparatuses, and non-transitory computer-readable medium may include further operations, features, means, or instructions for applying the default frame priority to the first frame and selecting the traffic class that corresponds to the default frame priority based on a mapping table, where the first frame may be classified into the traffic class based on the default frame priority.

In some examples of the method, apparatuses, and non-transitory computer-readable medium described herein, the first frame excluding may be associated with a generic precision time protocol.

### BRIEF DESCRIPTION OF THE DRAWINGS

FIG. 1 illustrates an example of a wireless communications system that supports techniques for supporting untagged Ethernet frames in accordance with aspects of the present disclosure.

FIG. 2 illustrates an example of a wireless communications system that supports techniques for supporting untagged Ethernet frames in accordance with aspects of the present disclosure.

FIG. 3 illustrates an example of a classification scheme that supports techniques for supporting untagged Ethernet frames in accordance with aspects of the present disclosure.

FIG. 4 illustrates an example of a process flow in a system that supports techniques for supporting untagged Ethernet frames in accordance with aspects of the present disclosure.

FIGS. 5 and 6 show block diagrams of devices that support techniques for supporting untagged Ethernet frames in accordance with aspects of the present disclosure.

FIG. 7 shows a block diagram of a communications manager that supports techniques for supporting untagged Ethernet frames in accordance with aspects of the present disclosure.

FIG. 8 shows a diagram of a system including a UE that supports techniques for supporting untagged Ethernet frames in accordance with aspects of the present disclosure.

FIG. 9 shows a diagram of a system including a network entity that supports techniques for supporting untagged Ethernet frames in accordance with aspects of the present disclosure.

FIGS. 10 through 12 show flowcharts illustrating methods that support techniques for supporting untagged Ethernet frames in accordance with aspects of the present disclosure.

### DETAILED DESCRIPTION

Some wireless communications systems (e.g., fifth generation (5G) systems) may support the transmission of various types of frames as part of a protocol data unit (PDU) session that is established, for example, between a user equipment (UE) and a data network. A PDU session may be configured with various protocol types that define a communications protocol for messages associated with the PDU session, which may include Internet Protocol version 4 (IPv4), Internet Protocol version 6 (IPv6), Ethernet, or Unstructured. As an example, an Ethernet-type PDU session may support the transmission of Ethernet frames between a UE and a Layer 2 Ethernet data network. In some deployments, the system implementing an Ethernet-type PDU session may be configured as an Ethernet bridge (e.g., a logical bridge), where user plane ports may be located at one or more UEs and a user-plane function (UPF) of a network (e.g., a 5G network). In addition, such networks may enable the use of one or more communications schemes that are supported by the Ethernet data network, such as time-sensitive networking (TSN). TSN communications may be associated with deterministic messaging having relatively low packet delay variation and relatively low packet loss, and may further enable time-synchronization between devices, scheduling and traffic shaping, and communication path configurations, among other features.

Some wireless communications systems may accordingly support TSN communications through an Ethernet-type PDU session, which may include scheduled traffic enhancements, such as a traffic schedule per traffic class. In such cases, frames (e.g., virtual local area network (VLAN) data frames) associated with an Ethernet PDU session may include respective VLAN tags. In some aspects, a VLAN tag may be referred to as a VLAN header. The respective VLAN tags may indicate a priority value for the corresponding frame, which may map to a traffic class of a set of traffic classes based on a mapping table. Further, each traffic class of the set of traffic classes may be associated with a respective queue of a set of queues and the frames may be transmitted according to a schedule associated with the set of queues. For example, a network may transmit, to a first device, a frame including a VLAN tag indicating a frame priority. The first device may forward the frame to a second device and the second device may select a traffic class that corresponds to the frame priority based on a mapping table. Further, the second device may classify the frame into a queue of a set of queues associated with the selected traffic class and may transmit the frame according to a schedule associated with the set of queues.

In some cases, however, a frame associated with an Ethernet PDU session may exclude a VLAN tag. For instance, a frame may exclude the VLAN tag based on a format or configuration of the frame (e.g., a generic precision time protocol (gPTP) frame). In other examples, a device may not be able to include a VLAN tag to a frame based on the device's capabilities. In any case, the absence of the VLAN tag may result in a device in a wireless communications system being unaware of a priority associated with a frame or how to classify the frame into a traffic class for scheduling. As such, the absence of a framework for prioritizing such frames (e.g., in the 5G system) may result in a device incorrectly classifying the Ethernet frame into a queue designated for relatively higher priority traffic, which may interrupt a gate schedule, resulting in a disruption of communications and other issues.

Accordingly, techniques described herein may enable the support of untagged Ethernet frames associated with a PDU session. For example, a network may transmit, to a first device, a frame associated with an Ethernet PDU session excluding a VLAN tag (e.g., an untagged Ethernet frame). In some cases, the first device may forward the frame to a second device and the second device may classify the frame into a traffic class based on the frame excluding a VLAN tag. In this way, communications may be improved by classifying untagged Ethernet frames, thus reducing interruptions to a gate schedule associated with the communications.

In some cases, the second device may determine a default traffic class or a default frame priority for the frame and the traffic class for the frame may be determined based on the default frame priority or default traffic class. The default traffic class or default frame priority may be signaled by a network entity. In some other cases, the default traffic class or default frame priority may be preconfigured (e.g., preconfigured at the first device and/or the second device). Additionally, or alternatively, the first device may add (e.g., append) a data tag to the frame indicating priority information for the untagged Ethernet frame. In some cases, the priority information may include a VLAN identifier and a priority value. In some other cases, the priority information may include metadata (e.g., a metadata suffix) indicating a default frame priority value. The first device may forward the frame, including the data tag, to the second wireless device and the second wireless device may remove the data tag and determine the priority information for the frame based on the data tag. As such, the added data tag may be used internally by devices within the wireless communications system to indicate the priority of the corresponding frame.

The second wireless device may classify the frame to a traffic class based on the priority information. In some cases, the second wireless device may classify the frame to a traffic class based on the default traffic class. In some other cases, the second wireless device may apply the default frame priority to the frame and select a traffic class for the first frame that corresponds to the default frame priority based on a mapping table. Further, the second device may sort the frame into a queue of a set of queues based on the traffic class and may transmit the frame based on a schedule associated with the set of queues.

Particular aspects of the subject matter described herein may be implemented to realize one or more of the following potential advantages. The techniques employed by the described communication devices may provide benefits and enhancements to the operation of the communication devices, including improved communication reliability and reduced latency, among other advantages, by providing a mechanism to classify untagged Ethernet frames. For example, operations performed by the described communication devices may provide improvements to communications (e.g., TSN communications) by classifying untagged Ethernet frames, thus reducing interruptions to a gate schedule associated with the communications. In some other implementations, operations performed by the described communication devices may also support improvements to increased data rates and, in some examples, low latency for communications, among other benefits.

Aspects of the disclosure are initially described in the context of wireless communications systems. Aspect of the disclosure are then described in the context of a classification scheme and a process flow. Aspects of the disclosure are further illustrated by and described with reference to apparatus diagrams, system diagrams, and flowcharts that relate to techniques for supporting untagged Ethernet frames.

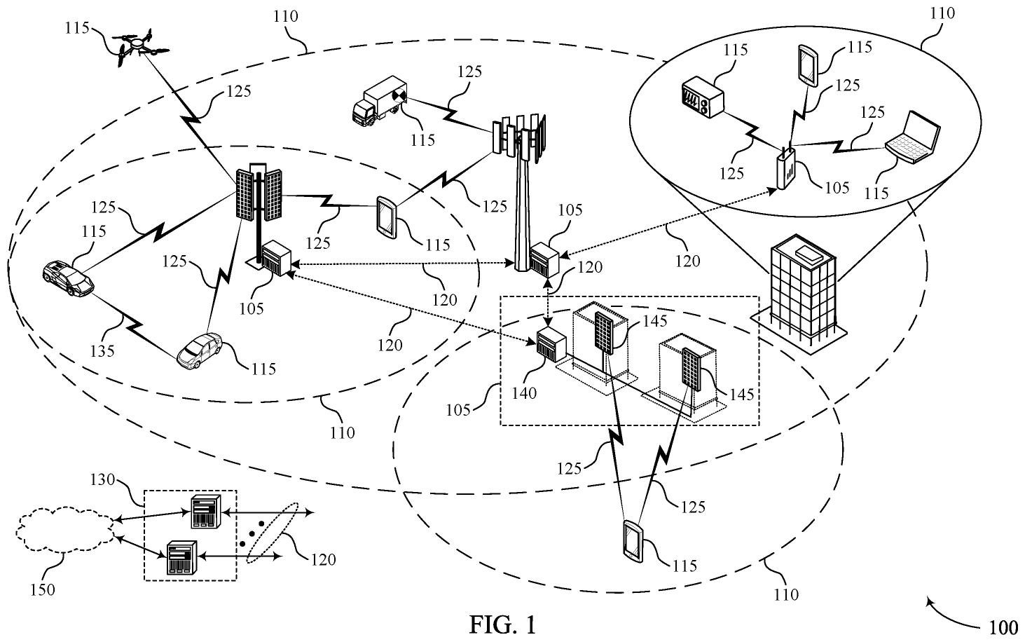

FIG. 1 illustrates an example of a wireless communications system 100 that supports techniques for supporting untagged Ethernet frames in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node, which may also be referred to as a network entity, may refer to any UE 115, base station 105, entity of a core network 130, user plane function (UPF), apparatus, device, or computing system configured to perform any techniques described herein. For example, a network node may be a UE 115. As another example, a network node may be a base station 105. For example, a network node can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ−N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Wireless communications system 100 (e.g., a 5G system) may support the transmission of various types of frames as part of a PDU session that is established, for example, between a UE 115 and a data network. For instance, the wireless communications system 100 may include or interface with a wired network (or with one or more components of a wired network), such as an Ethernet network or other wired network that implements. As such, a PDU session may be configured with protocol types that define a communications protocol for messages associated with the PDU session, which may include IPv4, IPv6, Ethernet, or Unstructured, among other examples. An Ethernet-type PDU session may support the transmission of Ethernet frames between a UE and a Layer 2 Ethernet data network. In some deployments, the wireless communications system 100 implementing an Ethernet-type PDU session may be configured as an Ethernet bridge (e.g., a logical bridge), where user plane ports may be located at one or more UEs and a UPF of the system.

In some examples, the Ethernet network may implement aspects of a TSN. TSN communications may be associated with deterministic messaging having relatively low packet delay variation and relatively low packet loss, and may further enable time-synchronization between devices, scheduling and traffic shaping, and communication path configurations, among other features. In some cases, the Ethernet network may feature a central manager, such as a CNC entity, that configures scheduling timelines or otherwise provides timing control information to one or more components of the wired network and, in some examples, to one or more components of the wireless communications system 100. For example, the wired network (e.g., the Ethernet network or the other wired network that implements TSN) may include one or more hops between a talker (e.g., a transmitting device) and a listener (e.g., a receiving device) and at least one of the one or more hops may be via a network entity over a wireless communications link.

The CNC entity may provide timing control information (e.g., gate scheduling information, filtering and policing control information) to each bridge between the talker and the listener to control the flow of data between the talker (e.g., a sender of data packets or frames) and the listener (e.g., a receiver of the data packets or frames). The CNC entity may schedule the transfer or flow of data between the components of the TSN system such that traffic patterns are fixed and predictable. For example, some industrial automation scenarios may be based on cyclic traffic patterns (e.g., controllers may regularly send control commands to actuators, such as a robot arm) and preserving the traffic pattern may increase the likelihood for successful communication and performance. In other words, some deployment scenarios may be associated with a strict traffic schedules and may be sensitive to traffic delays. For example, if commands reach an actuator too late, the actuator (e.g., a robot arm) may act too late, which may result in manufacturing errors (e.g., a dent in a surface being manufactured, a misplaced welding spot).

Ethernet networks with enhancements to reduce delay and jitter may be used for some industrial automation scenarios and may provide short cycle times with bounded jitter. In addition to or as an alternative to such Ethernet networks, one or more devices may implement TSN to bound latency or jitter, or both, and to avoid frame loss due to congestion in some Ethernet networks, such as switched Ethernet networks (e.g., including wired switches). In some deployments, TSN may serve as a common Layer 2 mechanism for time-sensitive traffic for industrial automation and other domains. As part of TSN, a TSN switch may employ a time-triggered forwarding process according to which the TSN switch receives traffic at one or ingress ports, selects an egress port based on a destination medium access control (MAC) address, selects a traffic class based on a priority field in a VLAN tag, and open gates for each of the different traffic classes in a predictable or cyclic manner. In some aspects, the opening of the gates for the different traffic classes may be in accordance with gate schedules or time-based transmission schedules (and may be configured by the CNC entity).

In some examples, the TSN may be integrated with or implemented for a 5G system (e.g., to allow factory networks to use wireless communication, such as 5G, instead of or in addition to wired networks that may use fiber or copper). In such cases, one or more components of wireless communications system 100 may operate to enable a TSN bridge (e.g., a 5G system TSN bridge). The 5G system, the TSN bridge, and the CNC entity may provide control commands to each of the TSN bridge, the 5G system, and the TSN bridge. Such control commands may include bridge management commands, which may include retrieving bridge capabilities from each bridge and providing timing control information, such as gate schedules, to each bridge. In some examples, the CNC entity may calculate the gate schedule for the TSN bridges based on constraints associated with the talker and the listener. Accordingly, each bridge may execute functions or operate in accordance with the bridge management commands received from the CNC entity.

In some examples, the techniques described herein may be relevant to or associated with messages exchanged in wireless communications system 100. For example, data frames exchanged between devices may be related to Ethernet ports located in a device-side TSN translator (DS-TT) (e.g., associated with a UE 115) and a network-side TSN translator (NW-TT) (e.g., associated with a network entity, such as a UPF). In some examples, the system may support a transfer of standardized and/or deployment-specific port management information between a TSN access function (AF) and the DS-TT or the NW-TT, respectively inside a port management information container (PMIC). The NW-TT and the DS-TT may support one or more ports, where each port may use a separate PMIC. The system may also support transfer of standards and deployment-specific bridge management information between the TSN AF and the NW-TT, respectively inside a bridge management information container (BMIC).

The wireless communications system 100 may support techniques for handling untagged Ethernet frames as described herein. For example, various devices (e.g., UEs 115, network nodes, network entities) may assigning priority information to untagged Ethernet frames. For example, a first device may receive an untagged Ethernet frame (e.g., an Ethernet frame excluding a VLAN tag), from a network (e.g., a TSN) and forward the untagged Ethernet frame to a second device. The second device may classify the untagged Ethernet frame according to a traffic class associated with a respective queue based on the exclusion of a VLAN tag and transmit the untagged Ethernet frame according to the traffic class and respective queue. Additionally, or alternatively, the first device may receive an untagged Ethernet frame from the network and may add a data tag indicating priority information to the untagged Ethernet frame. Further, the first device may forward the untagged Ethernet frame including the data tag to the second device. The second device may receive the untagged Ethernet frame including the data tag and may remove the data tag. Further, the second device may classify the untagged Ethernet frame according to a traffic class associated with a respective queue based on the priority information indicated by the data tag and may transmit the untagged Ethernet frame according to the traffic class and respective queue.

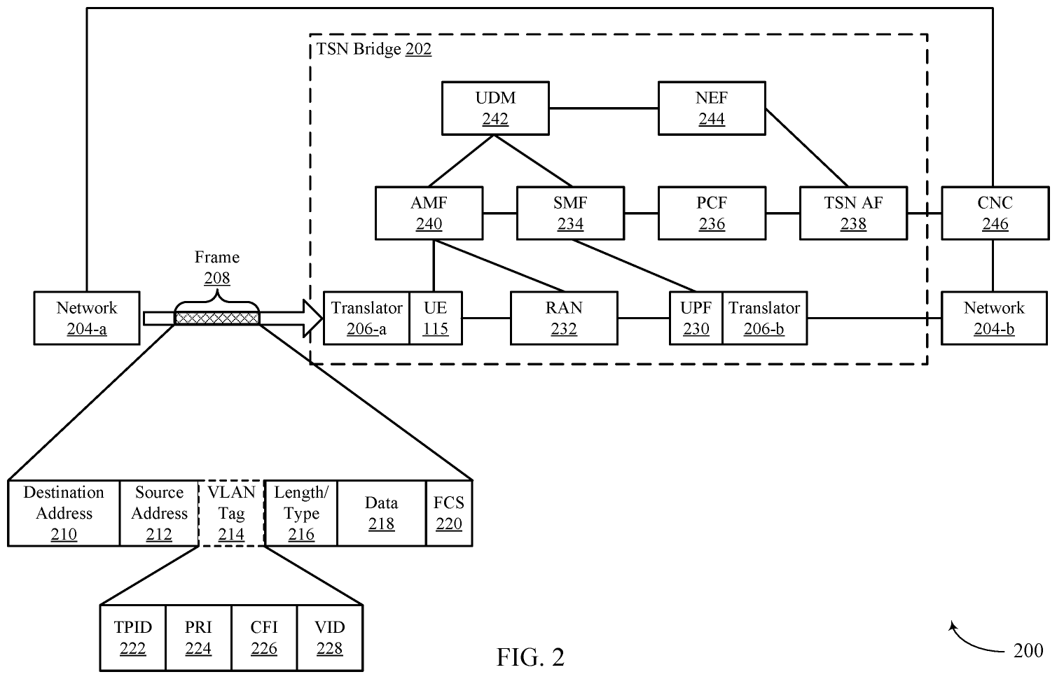

FIG. 2 illustrates an example of a wireless communications system 200 that supports techniques for supporting untagged Ethernet frames in accordance with aspects of the present disclosure. In some examples, wireless communications system 200 may implement aspects of wireless communications system 100. For example, a network 204 may transmit one or more frames 208 associated with an Ethernet-type PDU session to a first device, such as a translator 206-a (e.g., a DS-TT) associated with a UE 115 or a translator 206-b (e.g., an NW-TT), via one or more communication links as described with reference to FIG. 1. It is noted that the operations in wireless communications system 200 performed by the translator 206-a and translator 206-b may be performed by one or more other wireless devices or components thereof, and the example shown should not be construed as limiting to the claims or disclosure. For instance, the operations described as performed by the translator 206-a may be performed by the translator 206-b, and the operations shown as performed by the translator 206-b may be performed by the translator 206-a.

Some wireless communications systems (e.g., 5G systems) may support Ethernet-type PDU sessions, as well as TSN. Wireless communications system 200 may accordingly perform or enable aspects of a TSN bridge 202 (e.g., an Ethernet bridge, a logical bridge) provided by, for example, a 5G system, to support communications between a network 204-a and a network 204-b. The TSN bridge 202 may also include an access and mobility management function (AMF) 240, unified data management (UDM) 242, and a network exposure function (NEF) 244. Further, the networks 204 may communicate with a CNC entity 246.

TSN may enable scheduled traffic enhancements (e.g., time triggered gate scheduling) for communications from the network 204-a to the network 204-b via the TSN bridge 202, such as a traffic schedule per traffic class. That is, frames associated with an Ethernet-type PDU session, such as a frame 208, may include respective headers that include VLAN tags, such as a VLAN tag 214 (e.g., in an Ethernet header). For example, the network 204-a may transmit the frame 208 to the translator 206-a. The frame 208 may include a destination address 210, a source address 212, the VLAN tag 214, a length/type 216, data 218, and a frame sequence check (FCS) 220. Further, the VLAN tag 214 may include a tag protocol identifier (TPID) 222, a priority code point (PRI) 224, a canonical format indicator (CFI) 226, and a VLAN ID (VID) 228.

The translator 206-a may forward the frame 208 to a second device, such as the translator 206-b, associated with a UPF 230, via a radio access network (RAN) 232. The translator 206-b may extract a frame priority indicated by the PRI 224 from the VLAN tag 214 and classify the frame 208 into a traffic class based on the frame priority. For example, the translator 206-b may map the frame priority to the traffic class based on a mapping table (e.g., priority to traffic class mapping table). The mapping table may be configured for the TSN bridge 202 and may map multiple frame priority values to respective traffic class values.

In some cases, the translator 206-b may sort the frame 208 into an queue (e.g., an egress queue) of a bridge port (e.g., an egress Ethernet port associated with the translator 206-b) based on the traffic class. That is, each traffic class of a set of traffic classes may map to a respective queue of a set of queues (e.g., a one-to-one mapping). Further, the translator 206-b may transmit the frame 208 to a network 204-b according to a schedule associated with the set of queues, which may be referred to as a gate schedule. For example, a first queue may be associated with high priority traffic and a second queue may be associated with low priority traffic. As such, a gate schedule may indicate that frames 208 sorted into the first queue may be transmitted prior to frames 208 sorted into the second queue.

In some cases, however, the frame 208 may exclude a VLAN tag 214. In such cases, the translator 206-b may incorrectly classify the frame 208 into a queue designated for higher priority traffic, which may interrupt the gate schedule, resulting in a disruption of TSN communications, among other issues.

As described herein, wireless communications system 200 may support a framework for handling untagged Ethernet frames (e.g., a frame 208 that excludes the VLAN tag 214). In some cases, the network 204-a may transmit a frame 208 excluding the VLAN tag 214 (e.g., a gPTP frame used for time synchronization) to the translator 206-a associated with a UE 115. In some examples, the translator 206-a may forward the frame 208 to the translator 206-b associated with the UPF 230 via a RAN 232. A network entity may transmit signaling (e.g., via PMIC signaling, BMIC signaling) to the translator 206-b indicating a default frame priority or a default traffic class (e.g., configuration information) for the frame 208. The network entity may include a session management function (SMF) 234, a policy control function (PCF) 236, or a TSN AF 238. In other examples, the network entity may be an example of a time-sensitive communication and time synchronization function (not shown). Alternatively, or alternatively, the default frame priority and/or the default traffic class may be preconfigured at the translator 206-b, at the translator 206-b, or vice versa.

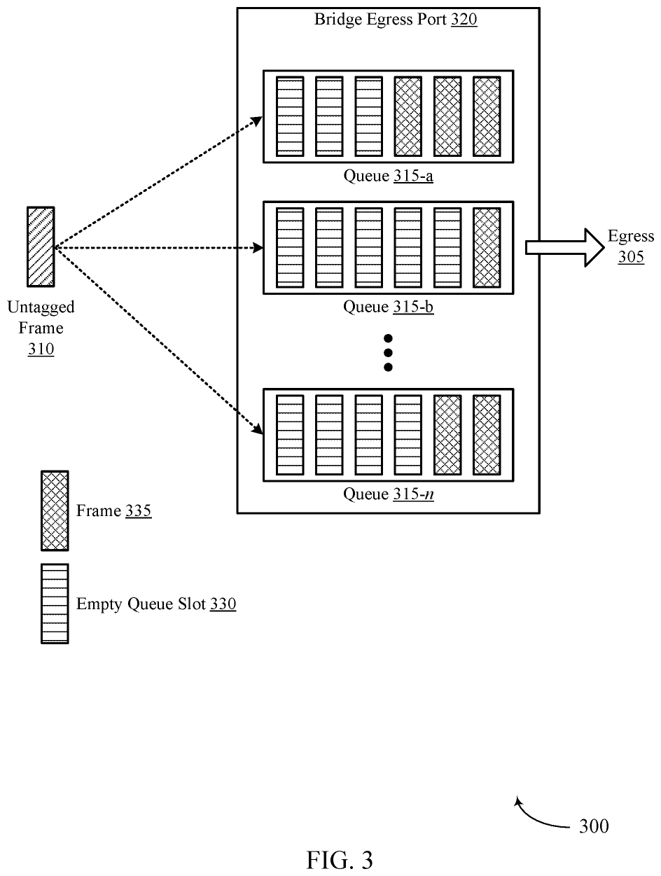

In some cases, the translator 206-b may apply the default frame priority to the frame 208 and may select a traffic class that corresponds to the default frame priority based on a mapping table. Further, the translator 206-b may classify the frame 208 to the traffic class associated with a respective queue based on the default frame priority. In some other cases, the translator 206-b may classify the frame 208 to the traffic class associated with a respective queue based on the default traffic class. The translator 206-b may sort the frame 208 into a queue of a bridge port (e.g., an Ethernet port associated with the translator 206-b) based on the traffic class, as further described with respect to FIG. 3. Further, the translator 206-b may transmit the frame 208 to a network 204-b according to a gate schedule associated with the set of egress queues.

Thus, for Ethernet frames that contain a VLAN tag, the translator 206-a (e.g., a DS-TT) and the translator 206-b (e.g., an NW-TT) may determine a queue (identified by traffic class) based on a priority value (e.g., a priority code point (PCP) value) contained in the VLAN tag and a traffic class table received from the TSN AF 238. For Ethernet frames that do not contain a VLAN tag, the translator 206-a (e.g., a DS-TT) and the translator 206-b (e.g., an NW-TT) may determine the queue (identified by traffic class) based on a default traffic class value received from TSN AF 238 (e.g., via a PMIC). In some examples, a configuration of the default traffic class (e.g., using PMIC) may be optional, and a translator 206 (e.g., translator 206-a, translator 206-b) may be pre-configured with the default traffic class.

In another example, the translator 206-a may receive the frame 208 excluding the VLAN tag 214 and may add (e.g., append), to the frame 208, a data tag (e.g., internal data tag) indicating priority information for the frame 208. In some cases, the data tag may include VLAN information signaled to one or both of the translators 206 by the network entity. The VLAN information may include a VLAN identifier (e.g., default VLAN ID), a frame priority (e.g., a default port priority), or both. In some other cases, the data tag may include metadata (e.g., a metadata suffix) associated with the frame 208 and the metadata may include (e.g., encapsulate) a frame priority (e.g., default frame priority) for the frame 208.

The translator 206-a may forward the frame 208 including the data tag to the translator 206-b associated with the UPF 230 and the translator 206-b may remove the data tag from the frame 208. In some cases, the translator 206-b may remove the data tag based on the information signaled to one or both of the translators 206 by the network entity and determine (e.g., extract) the priority information for the frame 208. For example, the translator 206-b may remove the data tag from the frame 208 based on the VLAN identifier associated with the frame 208 (e.g., the VLAN identifier may serve as a key to identify the data tag to be removed).

In some cases, the translator 206-b may apply the frame priority indicated by the priority information to the frame 208 and may select a traffic class that corresponds to the frame priority based on the mapping table. Further, the translator 206-b may classify the frame 208 to the traffic class associated with a respective queue based on the frame priority. The translator 206-b may sort the frame 208 into an queue of a bridge port (e.g., an Ethernet port attached to the translator 206-b) based on the traffic class. Further, the translator 206-b may transmit the frame 208 to a network 204-b according to a gate schedule associated with the set of egress queues.

FIG. 3 illustrates an example of a classification scheme 300 that supports techniques for supporting untagged Ethernet frames in accordance with aspects of the present disclosure. In some examples, the classification scheme 300 may be implemented by one or more devices, or components thereof, as described with reference to wireless communications system 100 and wireless communications system 200. For example, aspects of the classification scheme 300 may be performed by a translator 206 (e.g., a DS-TT, a NW-TT) as described with reference to FIG. 2.

In some cases, the translator performing aspects of classification scheme 300 may be associated with or located at an egress 305 (e.g., of a TSN bridge) and may receive an untagged frame 310. The untagged frame 310 may be associated with an Ethernet-type PDU session and may exclude a VLAN tag indicating a frame priority value. As such, the translator may assign a default frame priority or a default traffic class to the untagged frame 310. In some cases, a network entity (e.g., an SMF, a PCF, a TSN AF, a time-sensitive communication and time synchronization function) may transmit signaling indicating the default frame priority and the translator may apply the default frame priority to the untagged frame 310 based on the signaling. In other examples, the default frame priority and/or the default traffic class may be indicated by an internal data tag included (e.g., added to, appended to) the untagged frame 310. Here, the data tag may be an example of metadata (a metadata suffix) that indicate a priority of the untagged frame 310 and that is added to the untagged frame 310 (e.g., by a translator associated with an ingress port). The data tag may include an indication of a VLAN identifier and a default port priority which may be used for classifying the untagged frame 310 in accordance with the classification scheme 300. Additionally or alternatively, the default frame priority and/or the default traffic class may be preconfigured. In any case, the translator may select a traffic class for the untagged frame 310 using the default frame priority. That is, the translator may map the default frame priority to the traffic class based on a mapping table, which may map a plurality of frame priorities to respective traffic classes. In other cases, the translator may determine the traffic class for the untagged frame 310 based on the default traffic class.

Further, the translator may sort the untagged frame 310 into a queue 315 (e.g., one of queues 315-a through 315-n) located at a bridge egress port 320 (e.g., sort into an empty queue slot 330) based on the traffic class. For example, a first traffic class may be associated with a queue 315-a, a second traffic class may be associated with a queue 315-b, and a third traffic class may be associated with a queue 315-n. Further, the translator may transmit the untagged frame 310 from the bridge egress port 320 according to a schedule associated with the queues 315. For example, the queue 315-a may be associated with relatively high priority traffic and the queue 315-n may be associated with relatively low priority traffic. As such, the translator may transmit frames 335 in the queue 315-a prior to transmitting frames 335 in the queue 315-n.

While described in the context of a translator, it is understood that aspects of the classification scheme 300 may be performed by a device or plurality of devices capable of performing the techniques described herein.

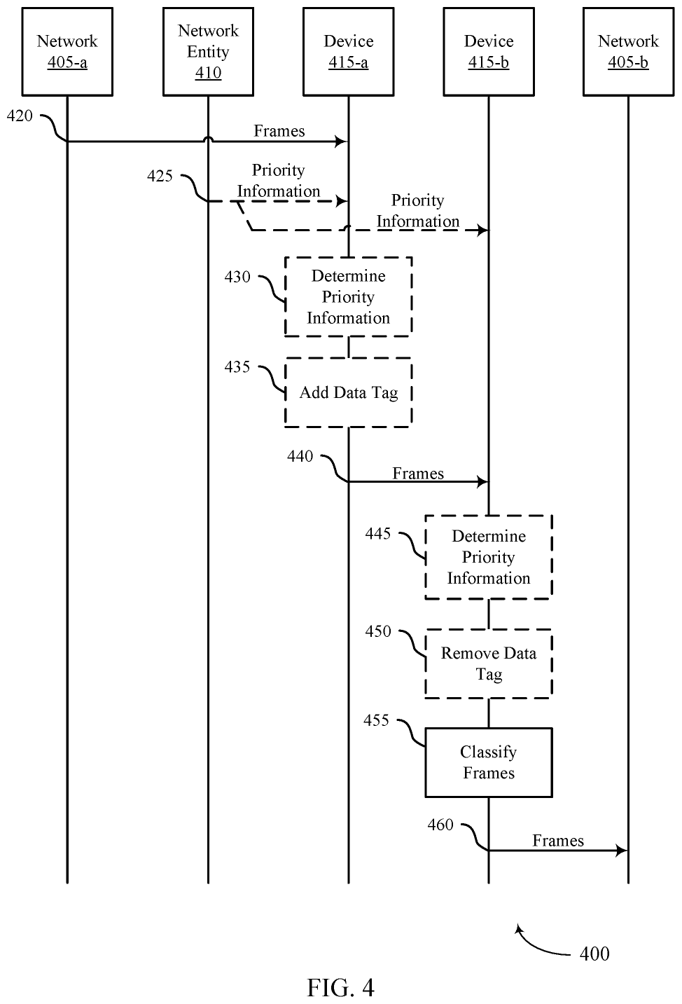

FIG. 4 illustrates an example of a process flow 400 in a system that supports techniques for supporting untagged Ethernet frames in accordance with aspects of the present disclosure. In some examples, the process flow 400 may implement aspects of the wireless communications system 100, the wireless communications system 200. For example, the process flow 400 may include networks 405 and devices 415, which may be examples of networks 204 and translators 206, respectively, as described with reference to FIG. 2.

At 420, a network 405-a may transmit, to a device 415-a (e.g., associated with a DS-TT or a NW-TT), one or more frames associated with an Ethernet-type PDU session, including a first frame which may exclude a VLAN tag. In other words, the first frame may not include a VLAN tag and may be considered an untagged frame. In some cases, the first frame may be associated with a gPTP (e.g., the first frame may be a gPTP frame used for time synchronization).

In some cases, at 425, the network entity 410 may transmit, to the device 415-a and the device 415-b, signaling indicating priority information for the first frame based on the first frame excluding the VLAN tag. In some cases, the priority information may include a default traffic class or a default frame priority for frames that exclude a VLAN tag. In some other cases, the priority information may include default VLAN information, which may further include a VLAN identifier value and a priority value. Additionally or alternatively, the signaling may include information associated with a data tag, such as the VLAN identifier. In some cases, the signaling may include PMIC signaling, BMIC signaling, or the like.

In some examples, at 430, the device 415-a may determine the priority information for the first frame. In some cases, the priority information may be based on the signaling from the network entity 410 at 425. For example, the device 415-a may assign the VLAN identifier and the priority value to the first frame based on the default VLAN information. In some other cases, the priority information may include the default frame priority and/or the default traffic class. Additionally, or alternatively, the device 415-a may determine the priority information based on a default traffic class and/or a default priority, for frames that exclude a VLAN tag, that is preconfigured at device 415-a (e.g., independent of signaling from network entity 410).

In some cases, at 435, the device 415-a may add a data tag to the first frame indicating the priority information. In some examples, the data tag may include the VLAN identifier, the frame priority, the traffic class, or any combination thereof. Alternatively, the data tag may include metadata associated with the first frame, where the metadata may indicate the priority and/or the traffic class of the first frame. In some cases, the priority information may be encapsulated in a metadata suffix and added to the first frame.

At 440, the device 415-a may forward the one or more frames, including the first frame, to a device 415-b (e.g., a DS-TT, a NW-TT). At 445, the device 415-b may determine priority information for the first frame based on the first frame excluding the VLAN tag. In some cases, the priority information may be based on the signaling received from the network entity 410 indicating the default traffic class or default frame priority. Alternatively, the priority information may be based on a default traffic class or a default frame priority preconfigured at the device 415-b. In some cases, the priority information determined by the device 415-b may be based on the data tag or the metadata suffix added to the first frame.

In some cases, at 450, the device 415-b may remove the data tag from the first frame. In other words, the data tag is removed from the first frame received from device 415-a such that device 415-b may forward the first fame (e.g., at 460) without including the data tag in the forwarded first frame. In some examples, the device 415-b may remove the data tag based on the signaling received from the network entity 410 at 425. For example, the device 415-b may remove the data tag based on the VLAN identifier associated with the first frame matching the VLAN identifier received in the priority information at 425. For example, the signaling received from the network entity 410 at 425 may identify VLAN tags, that are added by the device 415-a or the device 415-b (e.g., a DS-TT or a NW-TT), by indicating a VLAN identifier. Additionally, or alternatively, the device 415-b may remove the metadata suffix from the first frame before forwarding the first frame (e.g., at 460).

At 455, the device 415-b may classify each frame of the one or more frames according to multiple traffic classes that are each associated with a respective queue. The first frame may be classified into a traffic class based on the priority information, which, in some cases, may be indicated by the data tag or the metadata suffix. In some cases, the priority information may include the default frame priority and the device 415-b may apply the default frame priority to the first frame. Further, the device 415-b may select the traffic class that corresponds to the default frame priority based on a mapping table and may classify the first frame into a traffic class based on the default frame priority. Alternatively, the priority information may include the default traffic class and the device 415-b may classify the first frame into the traffic class based on the default traffic class.

At 460, the device 415-b may transmit, to a network 405-b, the one or more frames based on the multiple traffic classes and the respective queues.

Though described in the context of devices 415 and the network entity 410, it is understood that the techniques described herein may be performed by any type or quantity of devices. For example, the network entity 410 may include at least one of an SMF, a PCF, a TSN AF, or a time-sensitive communication and time synchronization function. Further, the each device 415 may be associated with a UE 115 or a network node.

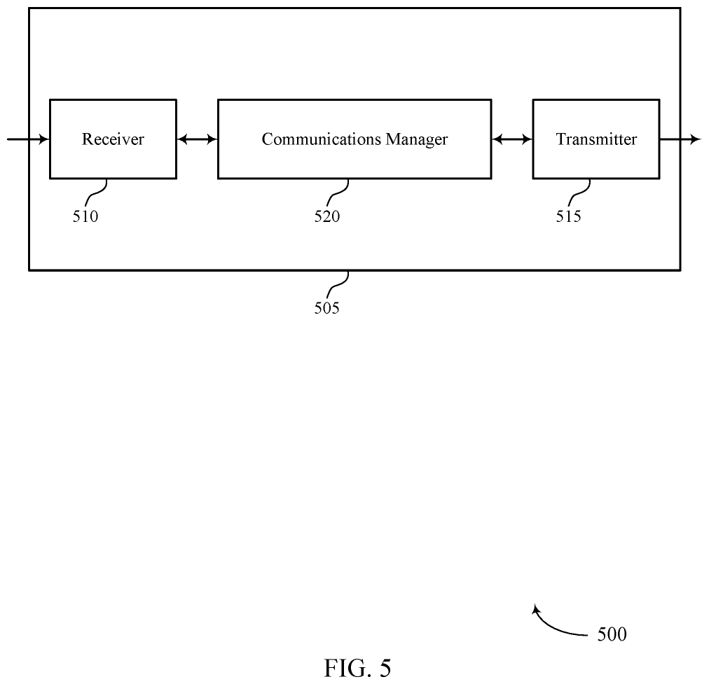

FIG. 5 shows a block diagram 500 of a device 505 that supports techniques for supporting untagged Ethernet frames in accordance with aspects of the present disclosure. The device 505 may be an example of aspects of a network node, a network entity, a UPF, or a UE 115, as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for supporting untagged Ethernet frames). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for supporting untagged Ethernet frames). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for supporting untagged Ethernet frames as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications in accordance with examples as disclosed herein. For example, the communications manager 520 may be configured as or otherwise support a means for receiving, at a first device, one or more frames from a second device, the one or more frames being associated with an Ethernet-type protocol data unit session, where a first frame of the one or more frames excludes a VLAN tag. The communications manager 520 may be configured as or otherwise support a means for classifying each frame of the one or more frames according to a set of multiple traffic classes that are each associated with a respective queue, where the first frame is classified into a traffic class based on the first frame excluding the VLAN tag. The communications manager 520 may be configured as or otherwise support a means for transmitting, from the first device, the one or more frames based on the set of multiple traffic classes and the respective queues.

For example, the communications manager 520 may be configured as or otherwise support a means for receiving, at a first device, one or more frames from a network, the one or more frames being associated with an Ethernet-type protocol data unit session, where a first frame of the one or more frames excludes a VLAN tag. The communications manager 520 may be configured as or otherwise support a means for adding, to the first frame, a data tag indicating priority information for the first frame based on the first frame excluding the VLAN tag. The communications manager 520 may be configured as or otherwise support a means for forwarding, to a second device, the one or more frames including the first frame and the data tag.

For example, the communications manager 520 may be configured as or otherwise support a means for receiving, at a second device, one or more frames from a first device, where a first frame of the one or more frames includes a data tag that indicates priority information for the first frame. The communications manager 520 may be configured as or otherwise support a means for removing the data tag from the first frame. The communications manager 520 may be configured as or otherwise support a means for classifying each frame of the one or more frames according to a set of multiple traffic classes that are each associated with a respective queue, where the first frame is classified into a traffic class based on the priority information indicated by the data tag. The communications manager 520 may be configured as or otherwise support a means for transmitting, from the second device, the one or more frames based on the set of multiple traffic classes and the respective queues.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for supporting untagged Ethernet frames which may result in reduced processing, reduced power consumption, and more efficient utilization of communication resources, among other advantages.

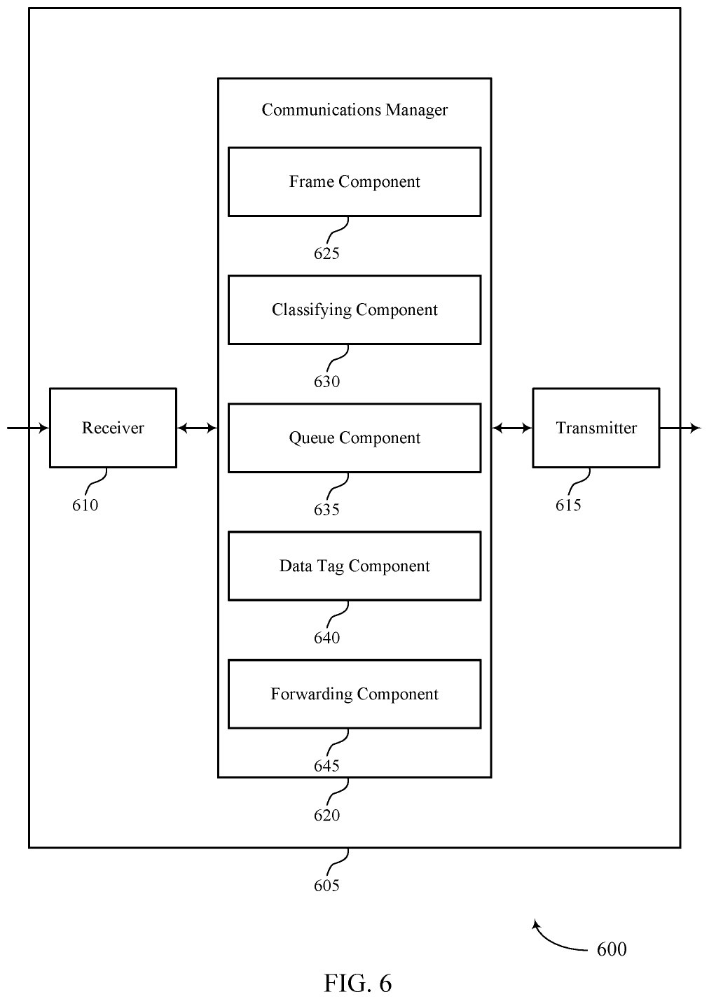

FIG. 6 shows a block diagram 600 of a device 605 that supports techniques for supporting untagged Ethernet frames in accordance with aspects of the present disclosure. The device 605 may be an example of aspects of a device 505, a network node, a network entity, a UPF, or a UE 115, as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for supporting untagged Ethernet frames). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for supporting untagged Ethernet frames). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for supporting untagged Ethernet frames as described herein. For example, the communications manager 620 may include a frame component 625, a classifying component 630, a queue component 635, a data tag component 640, a forwarding component 645, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications in accordance with examples as disclosed herein. The frame component 625 may be configured as or otherwise support a means for receiving, at a first device, one or more frames from a second device, the one or more frames being associated with an Ethernet-type protocol data unit session, where a first frame of the one or more frames excludes a VLAN tag. The classifying component 630 may be configured as or otherwise support a means for classifying each frame of the one or more frames according to a set of multiple traffic classes that are each associated with a respective queue, where the first frame is classified into a traffic class based on the first frame excluding the VLAN tag. The queue component 635 may be configured as or otherwise support a means for transmitting, from the first device, the one or more frames based on the set of multiple traffic classes and the respective queues.

The frame component 625 may be configured as or otherwise support a means for receiving, at a first device, one or more frames from a network, the one or more frames being associated with an Ethernet-type protocol data unit session, where a first frame of the one or more frames excludes a VLAN tag. The data tag component 640 may be configured as or otherwise support a means for adding, to the first frame, a data tag indicating priority information for the first frame based on the first frame excluding the VLAN tag. The forwarding component 645 may be configured as or otherwise support a means for forwarding, to a second device, the one or more frames including the first frame and the data tag.

The frame component 625 may be configured as or otherwise support a means for receiving, at a second device, one or more frames from a first device, where a first frame of the one or more frames includes a data tag that indicates priority information for the first frame. The data tag component 640 may be configured as or otherwise support a means for removing the data tag from the first frame. The classifying component 630 may be configured as or otherwise support a means for classifying each frame of the one or more frames according to a set of multiple traffic classes that are each associated with a respective queue, where the first frame is classified into a traffic class based on the priority information indicated by the data tag. The queue component 635 may be configured as or otherwise support a means for transmitting, from the second device, the one or more frames based on the set of multiple traffic classes and the respective queues.

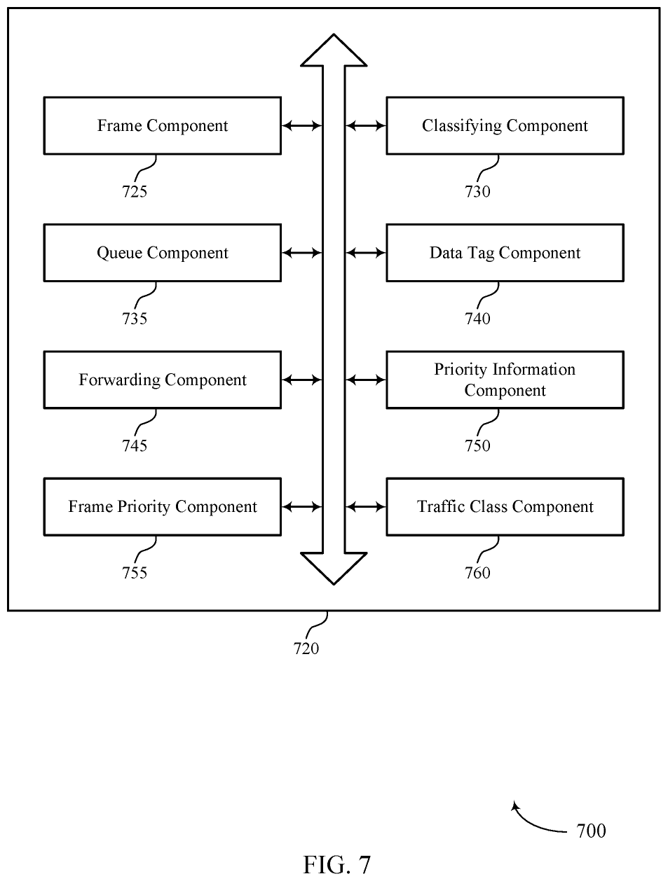

FIG. 7 shows a block diagram 700 of a communications manager 720 that supports techniques for supporting untagged Ethernet frames in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for supporting untagged Ethernet frames as described herein. For example, the communications manager 720 may include a frame component 725, a classifying component 730, a queue component 735, a data tag component 740, a forwarding component 745, a priority information component 750, a frame priority component 755, a traffic class component 760, or any combination thereof. Each of these components may communicate, directly or indirectly, with one another (e.g., via one or more buses).

The communications manager 720 may support wireless communications in accordance with examples as disclosed herein. The frame component 725 may be configured as or otherwise support a means for receiving, at a first device, one or more frames from a second device, the one or more frames being associated with an Ethernet-type protocol data unit session, where a first frame of the one or more frames excludes a VLAN tag. The classifying component 730 may be configured as or otherwise support a means for classifying each frame of the one or more frames according to a set of multiple traffic classes that are each associated with a respective queue, where the first frame is classified into a traffic class based on the first frame excluding the VLAN tag. The queue component 735 may be configured as or otherwise support a means for transmitting, from the first device, the one or more frames based on the set of multiple traffic classes and the respective queues.

In some examples, the priority information component 750 may be configured as or otherwise support a means for determining priority information for frames excluding the VLAN tag, where the first frame is classified based on the priority information.

In some examples, the priority information includes a default frame priority for frames excluding the VLAN tag, and the frame priority component 755 may be configured as or otherwise support a means for applying the default frame priority to the first frame. In some examples, the priority information includes a default frame priority for frames excluding the VLAN tag, and the traffic class component 760 may be configured as or otherwise support a means for selecting the traffic class that corresponds to the default frame priority based on a mapping table, where the first frame is classified into the traffic class based on the default frame priority.

In some examples, the priority information includes a default traffic class for frames excluding the VLAN tag. In some examples, the first frame is classified based on the default traffic class.

In some examples, the priority information component 750 may be configured as or otherwise support a means for receiving, from a network entity, signaling indicating the priority information, where the priority information is determined based on the signaling.

In some examples, the signaling is received via at least one of a PMIC or a BMIC. In some examples, the network entity includes an SMF, a PCF, a TSN AF, or a time-sensitive communication and time synchronization function.

In some examples, the priority information includes a default frame priority for frames excluding the VLAN tag, the default frame priority being preconfigured at the first device. In some examples, the first frame is classified based on the default frame priority and a mapping table.

In some examples, the priority information includes a default traffic class for frames excluding the VLAN tag, the default traffic class being preconfigured at the first device. In some examples, the first frame is classified based on the default traffic class.

In some examples, the first frame excluding the VLAN tag is associated with a gPTP. In some examples, the first device includes a UE and the second device is associated with a network entity. In some examples, the first device is associated with a network entity and the second device includes a UE.

In some examples, the frame component 725 may be configured as or otherwise support a means for receiving, at a first device, one or more frames from a network, the one or more frames being associated with an Ethernet-type protocol data unit session, where a first frame of the one or more frames excludes a VLAN tag. The data tag component 740 may be configured as or otherwise support a means for adding, to the first frame, a data tag indicating priority information for the first frame based on the first frame excluding the VLAN tag. The forwarding component 745 may be configured as or otherwise support a means for forwarding, to a second device, the one or more frames including the first frame and the data tag.

In some examples, the priority information component 750 may be configured as or otherwise support a means for determining the priority information for the first frame based on the first frame excluding the VLAN tag.

In some examples, the priority information component 750 may be configured as or otherwise support a means for receiving, from a network entity, signaling indicating the priority information for the first frame, where determining the priority information is based on the signaling.

In some examples, the priority information component 750 may be configured as or otherwise support a means for assigning default VLAN information to the first frame based on the signaling and the first frame excluding the VLAN tag, where the priority information includes an indication of the default VLAN information.

In some examples, the default VLAN information includes a VLAN identifier value and a priority value. In some examples, the data tag is based on the VLAN identifier value and the priority value.

In some examples, the signaling is received via at least one of a PMIC or a BMIC. In some examples, the data tag includes a VLAN identifier or a frame priority, or both. In some examples, the data tag includes metadata associated with the first frame, the metadata indicating a priority of the first frame.

In some examples, the priority information includes a default frame priority for frames excluding the VLAN tag.

In some examples, the first frame excluding the VLAN tag is associated with a gPTP.

In some examples, the frame component 725 may be configured as or otherwise support a means for receiving, at a second device, one or more frames from a first device, where a first frame of the one or more frames includes a data tag that indicates priority information for the first frame. In some examples, the data tag component 740 may be configured as or otherwise support a means for removing the data tag from the first frame. In some examples, the classifying component 730 may be configured as or otherwise support a means for classifying each frame of the one or more frames according to a set of multiple traffic classes that are each associated with a respective queue, where the first frame is classified into a traffic class based on the priority information indicated by the data tag. In some examples, the queue component 735 may be configured as or otherwise support a means for transmitting, from the second device, the one or more frames based on the set of multiple traffic classes and the respective queues.

In some examples, the priority information component 750 may be configured as or otherwise support a means for receiving, from a network entity, signaling including information associated with the data tag, where the data tag is removed based on the information associated with the data tag.

In some examples, the information associated with the data tag includes a VLAN identifier.

In some examples, the data tag includes a VLAN identifier and a default frame priority based on the priority information.

In some examples, the data tag includes metadata associated with the first frame. In some examples, the first frame is classified based on the metadata.

In some examples, the priority information includes a default frame priority, and the frame priority component 755 may be configured as or otherwise support a means for applying the default frame priority to the first frame. In some examples, the priority information includes a default frame priority, and the traffic class component 760 may be configured as or otherwise support a means for selecting the traffic class that corresponds to the default frame priority based on a mapping table, where the first frame is classified into the traffic class based on the default frame priority.

In some examples, the first frame excluding is associated with a gPTP.

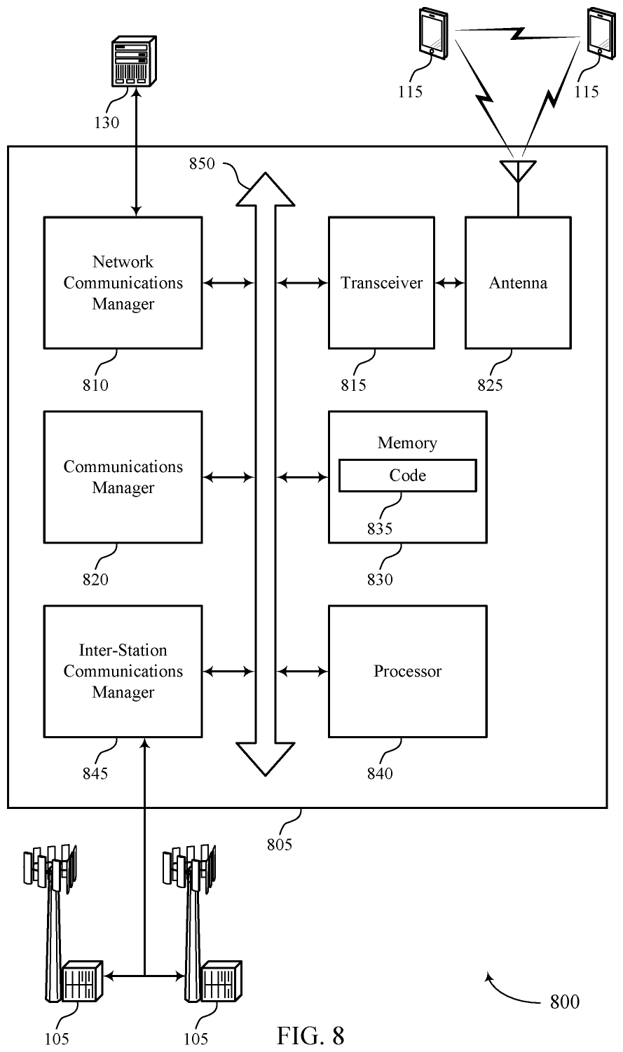

FIG. 8 shows a diagram of a system 800 including a device 805 that supports techniques for supporting untagged Ethernet frames in accordance with aspects of the present disclosure. The device 805 may be an example of or include the components of a device 505, a device 605, a network node, a network entity, or a UPF, as described herein. The device 805 may include components for bi-directional voice and data communications including components for transmitting and receiving communications, such as a communications manager 820, a network communications manager 810, a transceiver 815, an antenna 825, a memory 830, code 835, a processor 840, and an inter-station communications manager 845. These components may be in electronic communication or otherwise coupled (e.g., operatively, communicatively, functionally, electronically, electrically) via one or more buses (e.g., a bus 850).

The network communications manager 810 may manage communications with a core network 130 (e.g., via one or more wired backhaul links). For example, the network communications manager 810 may manage the transfer of data communications for client devices, such as one or more UEs 115.

In some cases, the device 805 may include a single antenna 825. However, in some other cases the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic input/output (I/O) system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for supporting untagged Ethernet frames). For example, the device 805 or a component of the device 805 may include a processor 840 and memory 830 coupled to the processor 840, the processor 840 and memory 830 configured to perform various functions described herein.

The inter-station communications manager 845 may manage communications with other base stations 105, and may include a controller or scheduler for controlling communications with UEs 115 in cooperation with other base stations 105. For example, the inter-station communications manager 845 may coordinate scheduling for transmissions to UEs 115 for various interference mitigation techniques such as beamforming or joint transmission. In some examples, the inter-station communications manager 845 may provide an X2 interface within an LTE/LTE-A wireless communications network technology to provide communication between base stations 105.

The communications manager 820 may support wireless communications in accordance with examples as disclosed herein. For example, the communications manager 820 may be configured as or otherwise support a means for receiving, at a first device, one or more frames from a second device, the one or more frames being associated with an Ethernet-type protocol data unit session, where a first frame of the one or more frames excludes a VLAN tag. The communications manager 820 may be configured as or otherwise support a means for classifying each frame of the one or more frames according to a set of multiple traffic classes that are each associated with a respective queue, where the first frame is classified into a traffic class based on the first frame excluding the VLAN tag. The communications manager 820 may be configured as or otherwise support a means for transmitting, from the first device, the one or more frames based on the set of multiple traffic classes and the respective queues.

For example, the communications manager 820 may be configured as or otherwise support a means for receiving, at a first device, one or more frames from a network, the one or more frames being associated with an Ethernet-type protocol data unit session, where a first frame of the one or more frames excludes a VLAN tag. The communications manager 820 may be configured as or otherwise support a means for adding, to the first frame, a data tag indicating priority information for the first frame based on the first frame excluding the VLAN tag. The communications manager 820 may be configured as or otherwise support a means for forwarding, to a second device, the one or more frames including the first frame and the data tag.

For example, the communications manager 820 may be configured as or otherwise support a means for receiving, at a second device, one or more frames from a first device, where a first frame of the one or more frames includes a data tag that indicates priority information for the first frame. The communications manager 820 may be configured as or otherwise support a means for removing the data tag from the first frame. The communications manager 820 may be configured as or otherwise support a means for classifying each frame of the one or more frames according to a set of multiple traffic classes that are each associated with a respective queue, where the first frame is classified into a traffic class based on the priority information indicated by the data tag. The communications manager 820 may be configured as or otherwise support a means for transmitting, from the second device, the one or more frames based on the set of multiple traffic classes and the respective queues.

By including or configuring the communications manager 820 in accordance with examples as described herein, the device 805 may support techniques for supporting untagged Ethernet frames which may result in improved communication reliability and reduced latency, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for supporting untagged Ethernet frames as described herein, or the processor 840 and the memory 830 may be otherwise configured to perform or support such operations.

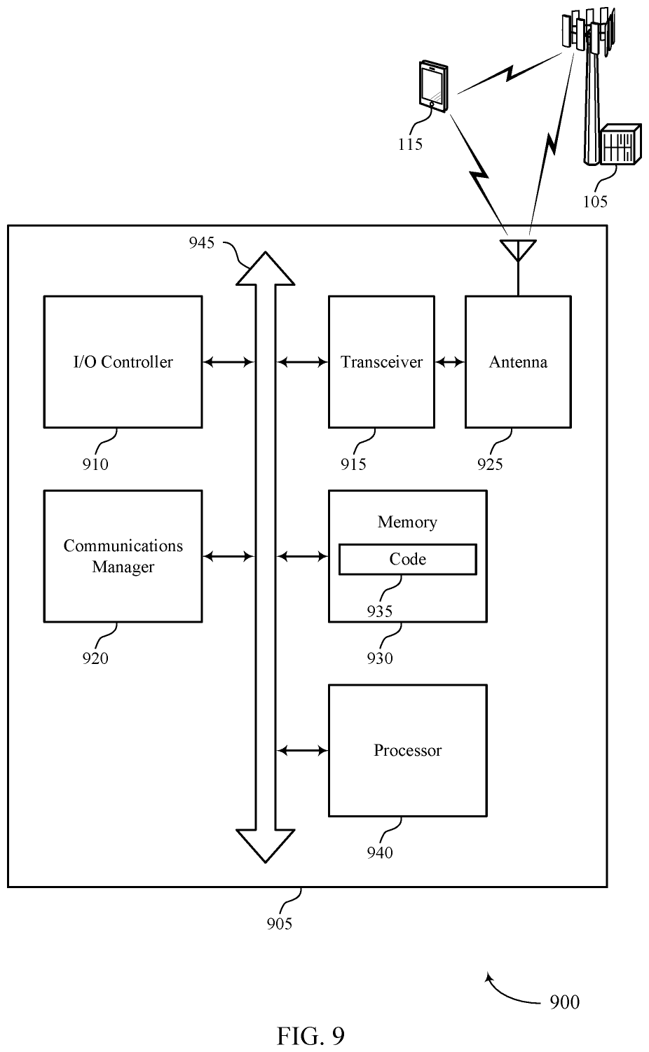

FIG. 9 shows a diagram of a system 900 including a device 905 that supports techniques for supporting untagged Ethernet frames in accordance with aspects of the present disclosure. The device 905 may be an example of or include the components of a device 505, a device 605, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an I/O controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 515, a transmitter 615, a receiver 510, a receiver 610, or any combination thereof or component thereof, as described herein.

The memory 930 may include RAM and ROM. The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a BIOS which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for supporting untagged Ethernet frames). For example, the device 905 or a component of the device 905 may include a processor 940 and memory 930 coupled with or to the processor 940, the processor 940 and memory 930 configured to perform various functions described herein.

The communications manager 920 may support wireless communications in accordance with examples as disclosed herein. For example, the communications manager 920 may be configured as or otherwise support a means for receiving, at a first device, one or more frames from a second device, the one or more frames being associated with an Ethernet-type protocol data unit session, where a first frame of the one or more frames excludes a VLAN tag. The communications manager 920 may be configured as or otherwise support a means for classifying each frame of the one or more frames according to a set of multiple traffic classes that are each associated with a respective queue, where the first frame is classified into a traffic class based on the first frame excluding the VLAN tag. The communications manager 920 may be configured as or otherwise support a means for transmitting, from the first device, the one or more frames based on the set of multiple traffic classes and the respective queues.

For example, the communications manager 920 may be configured as or otherwise support a means for receiving, at a first device, one or more frames from a network, the one or more frames being associated with an Ethernet-type protocol data unit session, where a first frame of the one or more frames excludes a VLAN tag. The communications manager 920 may be configured as or otherwise support a means for adding, to the first frame, a data tag indicating priority information for the first frame based on the first frame excluding the VLAN tag. The communications manager 920 may be configured as or otherwise support a means for forwarding, to a second device, the one or more frames including the first frame and the data tag.

For example, the communications manager 920 may be configured as or otherwise support a means for receiving, at a second device, one or more frames from a first device, where a first frame of the one or more frames includes a data tag that indicates priority information for the first frame. The communications manager 920 may be configured as or otherwise support a means for removing the data tag from the first frame. The communications manager 920 may be configured as or otherwise support a means for classifying each frame of the one or more frames according to a set of multiple traffic classes that are each associated with a respective queue, where the first frame is classified into a traffic class based on the priority information indicated by the data tag. The communications manager 920 may be configured as or otherwise support a means for transmitting, from the second device, the one or more frames based on the set of multiple traffic classes and the respective queues.

By including or configuring the communications manager 920 in accordance with examples as described herein, the device 905 may support techniques for supporting untagged Ethernet frames which may result in improved communication reliability and reduced latency, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for supporting untagged Ethernet frames as described herein, or the processor 940 and the memory 930 may be otherwise configured to perform or support such operations.

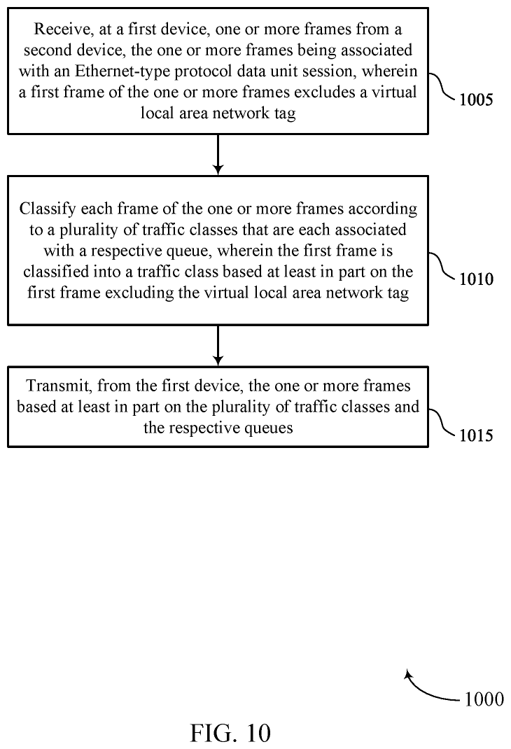

FIG. 10 shows a flowchart illustrating a method 1000 that supports techniques for supporting untagged Ethernet frames in accordance with aspects of the present disclosure. The operations of the method 1000 may be implemented by a network node, a network entity, a UPF, or a UE 115, or their components, as described herein. For example, the operations of the method 1000 may be performed by a network entity or a UE 115 as described with reference to FIGS. 1 through 9. In some examples, a network entity or a UE may execute a set of instructions to control the functional elements of the network entity or the UE to perform the described functions. Additionally or alternatively, the network entity or the UE may perform aspects of the described functions using special-purpose hardware.

At 1005, the method may include receiving, at a first device, one or more frames from a second device, the one or more frames being associated with an Ethernet-type protocol data unit session, where a first frame of the one or more frames excludes a VLAN tag. The operations of 1005 may be performed in accordance with examples as disclosed herein. In some examples, aspects of the operations of 1005 may be performed by a frame component 725 as described with reference to FIG. 7.

At 1010, the method may include classifying each frame of the one or more frames according to a set of multiple traffic classes that are each associated with a respective queue, where the first frame is classified into a traffic class based on the first frame excluding the VLAN tag. The operations of 1010 may be performed in accordance with examples as disclosed herein. In some examples, aspects of the operations of 1010 may be performed by a classifying component 730 as described with reference to FIG. 7.

At 1015, the method may include transmitting, from the first device, the one or more frames based on the set of multiple traffic classes and the respective queues. The operations of 1015 may be performed in accordance with examples as disclosed herein. In some examples, aspects of the operations of 1015 may be performed by a queue component 735 as described with reference to FIG. 7.

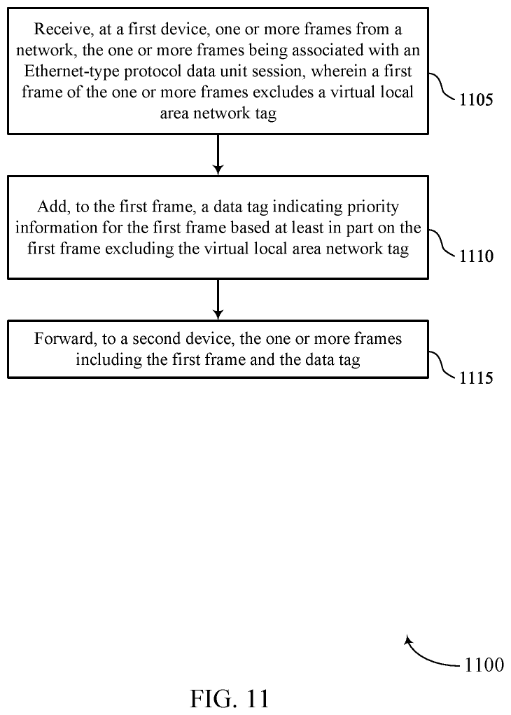

FIG. 11 shows a flowchart illustrating a method 1100 that supports techniques for supporting untagged Ethernet frames in accordance with aspects of the present disclosure. The operations of the method 1100 may be implemented by a network node, a network entity, a UPF, or a UE 115, or their components, as described herein. For example, the operations of the method 1100 may be performed by a network entity or a UE 115 as described with reference to FIGS. 1 through 9. In some examples, a network entity or a UE may execute a set of instructions to control the functional elements of the network entity or the UE to perform the described functions. Additionally or alternatively, the network entity or the UE may perform aspects of the described functions using special-purpose hardware.

At 1105, the method may include receiving, at a first device, one or more frames from a network, the one or more frames being associated with an Ethernet-type protocol data unit session, where a first frame of the one or more frames excludes a VLAN tag. The operations of 1105 may be performed in accordance with examples as disclosed herein. In some examples, aspects of the operations of 1105 may be performed by a frame component 725 as described with reference to FIG. 7.

At 1110, the method may include adding, to the first frame, a data tag indicating priority information for the first frame based on the first frame excluding the VLAN tag. The operations of 1110 may be performed in accordance with examples as disclosed herein. In some examples, aspects of the operations of 1110 may be performed by a data tag component 740 as described with reference to FIG. 7.

At 1115, the method may include forwarding, to a second device, the one or more frames including the first frame and the data tag. The operations of 1115 may be performed in accordance with examples as disclosed herein. In some examples, aspects of the operations of 1115 may be performed by a forwarding component 745 as described with reference to FIG. 7.

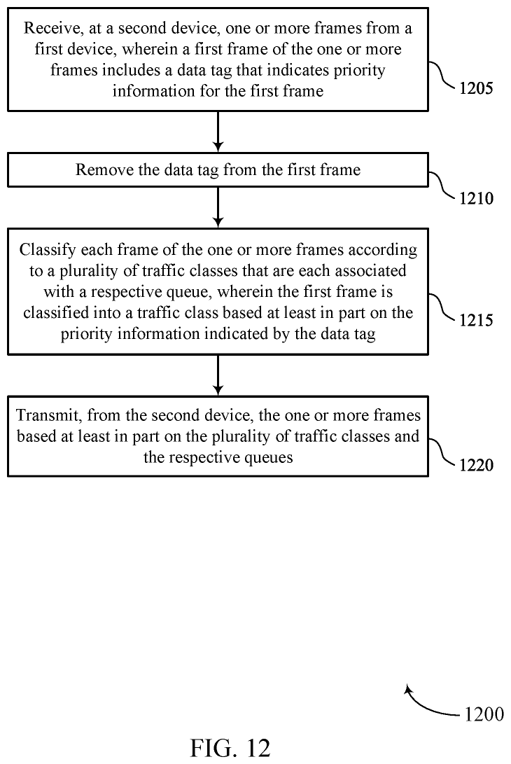

FIG. 12 shows a flowchart illustrating a method 1200 that supports techniques for supporting untagged Ethernet frames in accordance with aspects of the present disclosure. The operations of the method 1200 may be by a network node, a network entity, a UPF, or a UE 115, or their components, as described herein. For example, the operations of the method 1200 may be performed by a network entity or a UE 115 as described with reference to FIGS. 1 through 9. In some examples, a network entity or a UE may execute a set of instructions to control the functional elements of the network entity or the UE to perform the described functions. Additionally or alternatively, the network entity or the UE may perform aspects of the described functions using special-purpose hardware.

At 1205, the method may include receiving, at a second device, one or more frames from a first device, where a first frame of the one or more frames includes a data tag that indicates priority information for the first frame. The operations of 1205 may be performed in accordance with examples as disclosed herein. In some examples, aspects of the operations of 1205 may be performed by a frame component 725 as described with reference to FIG. 7.

At 1210, the method may include removing the data tag from the first frame. The operations of 1210 may be performed in accordance with examples as disclosed herein. In some examples, aspects of the operations of 1210 may be performed by a data tag component 740 as described with reference to FIG. 7.

At 1215, the method may include classifying each frame of the one or more frames according to a set of multiple traffic classes that are each associated with a respective queue, where the first frame is classified into a traffic class based on the priority information indicated by the data tag. The operations of 1215 may be performed in accordance with examples as disclosed herein. In some examples, aspects of the operations of 1215 may be performed by a classifying component 730 as described with reference to FIG. 7.

At 1220, the method may include transmitting, from the second device, the one or more frames based on the set of multiple traffic classes and the respective queues. The operations of 1220 may be performed in accordance with examples as disclosed herein. In some examples, aspects of the operations of 1220 may be performed by a queue component 735 as described with reference to FIG. 7.

Aspect 1: A method for wireless communications, comprising: receiving, at a first device, one or more frames from a second device, the one or more frames being associated with an Ethernet-type protocol data unit session, wherein a first frame of the one or more frames excludes a virtual local area network tag; classifying each frame of the one or more frames according to a plurality of traffic classes that are each associated with a respective queue, wherein the first frame is classified into a traffic class based at least in part on the first frame excluding the virtual local area network tag; and transmitting, from the first device, the one or more frames based at least in part on the plurality of traffic classes and the respective queues.

Aspect 2: The method of aspect 1, further comprising: determining priority information for frames excluding the virtual local area network tag, wherein the first frame is classified based at least in part on the priority information.

Aspect 3: The method of aspect 2, wherein the priority information comprises a default frame priority for frames excluding the virtual local area network tag, the method further comprising: applying the default frame priority to the first frame; and selecting the traffic class that corresponds to the default frame priority based at least in part on a mapping table, wherein the first frame is classified into the traffic class based at least in part on the default frame priority.

Aspect 4: The method of any of aspects 2 through 3, wherein the priority information comprises a default traffic class for frames excluding the virtual local area network tag, and the first frame is classified based at least in part on the default traffic class.

Aspect 5: The method of any of aspects 2 through 4, further comprising: receiving, from a network entity, signaling indicating the priority information, wherein the priority information is determined based at least in part on the signaling.

Aspect 6: The method of aspect 5, wherein the signaling is received via at least one of a port management information container or a bridge management information container.

Aspect 7: The method of any of aspects 5 through 6, wherein the network entity comprises a session management function, a policy control function, a time-sensitive networking application function, or a time-sensitive communication and time synchronization function.

Aspect 8: The method of any of aspects 2 through 7, wherein the priority information comprises a default frame priority for frames excluding the virtual local area network tag, the default frame priority being preconfigured at the first device, and the first frame is classified based at least in part on the default frame priority and a mapping table.

Aspect 9: The method of any of aspects 2 through 8, wherein the priority information comprises a default traffic class for frames excluding the virtual local area network tag, the default traffic class being preconfigured at the first device, and the first frame is classified based at least in part on the default traffic class.

Aspect 10: The method of any of aspects 1 through 9, wherein the first frame excluding the virtual local area network tag is associated with a generic precision time protocol.

Aspect 11: The method of any of aspects 1 through 10, wherein the first device comprises a UE and the second device is associated with a network entity.

Aspect 12: The method of any of aspects 1 through 11, wherein the first device is associated with a network entity and the second device comprises a UE.

Aspect 13: A method for wireless communications comprising: receiving, at a first device, one or more frames from a network, the one or more frames being associated with an Ethernet-type protocol data unit session, wherein a first frame of the one or more frames excludes a virtual local area network tag; adding, to the first frame, a data tag indicating priority information for the first frame based at least in part on the first frame excluding the virtual local area network tag; and forwarding, to a second device, the one or more frames including the first frame and the data tag.

Aspect 14: The method of aspect 13, further comprising: determining the priority information for the first frame based at least in part on the first frame excluding the virtual local area network tag.

Aspect 15: The method of aspect 14, further comprising: receiving, from a network entity, signaling indicating the priority information for the first frame, wherein determining the priority information is based at least in part on the signaling.

Aspect 16: The method of aspect 15, further comprising: assigning default virtual local area network information to the first frame based at least in part on the signaling and the first frame excluding the virtual local area network tag, wherein the priority information comprises an indication of the default virtual local area network information.

Aspect 17: The method of aspect 16, wherein the default virtual local area network information comprises a virtual local area network identifier value and a priority value, and the data tag is based at least in part on the virtual local area network identifier value and the priority value.

Aspect 18: The method of any of aspects 15 through 17, wherein the signaling is received via at least one of a port management information container or a bridge management information container.

Aspect 19: The method of any of aspects 13 through 18, wherein the data tag comprises a virtual local area network identifier or a frame priority, or both.

Aspect 20: The method of any of aspects 13 through 19, wherein the data tag comprises metadata associated with the first frame, the metadata indicating a priority of the first frame.

Aspect 21: The method of any of aspects 13 through 20, wherein the priority information comprises a default frame priority for frames excluding the virtual local area network tag.

Aspect 22: The method of any of aspects 13 through 21, wherein the first frame excluding the virtual local area network tag is associated with a generic precision time protocol.

Aspect 23: A method for wireless communications comprising: receiving, at a second device, one or more frames from a first device, wherein a first frame of the one or more frames includes a data tag that indicates priority information for the first frame; removing the data tag from the first frame; classifying each frame of the one or more frames according to a plurality of traffic classes that are each associated with a respective queue, wherein the first frame is classified into a traffic class based at least in part on the priority information indicated by the data tag; and transmitting, from the second device, the one or more frames based at least in part on the plurality of traffic classes and the respective queues.

Aspect 24: The method of aspect 23, further comprising: receiving, from a network entity, signaling comprising information associated with the data tag, wherein the data tag is removed based at least in part on the information associated with the data tag.

Aspect 25: The method of aspect 24, wherein the information associated with the data tag comprises a virtual local area network identifier.

Aspect 26: The method of any of aspects 23 through 25, wherein the data tag comprises a virtual local area network identifier and a default frame priority based at least in part on the priority information.

Aspect 27: The method of any of aspects 23 through 26, wherein the data tag comprises metadata associated with the first frame, the first frame is classified based at least in part on the metadata.

Aspect 28: The method of any of aspects 23 through 27, wherein the priority information comprises a default frame priority, the method further comprising: applying the default frame priority to the first frame; and selecting the traffic class that corresponds to the default frame priority based at least in part on a mapping table, wherein the first frame is classified into the traffic class based at least in part on the default frame priority.

Aspect 29: The method of any of aspects 23 through 28, wherein the first frame excluding is associated with a generic precision time protocol.

Aspect 30: An apparatus for wireless communications, comprising a processor; memory coupled with the processor; and instructions stored in the memory and executable by the processor to cause the apparatus to perform a method of any of aspects 1 through 12.

Aspect 31: An apparatus for wireless communications, comprising at least one means for performing a method of any of aspects 1 through 12.

Aspect 32: A non-transitory computer-readable medium storing code for wireless communications, the code comprising instructions executable by a processor to perform a method of any of aspects 1 through 12.

Aspect 33: An apparatus comprising a processor; memory coupled with the processor; and instructions stored in the memory and executable by the processor to cause the apparatus to perform a method of any of aspects 13 through 22.

Aspect 34: An apparatus comprising at least one means for performing a method of any of aspects 13 through 22.

Aspect 35: A non-transitory computer-readable medium storing code the code comprising instructions executable by a processor to perform a method of any of aspects 13 through 22.

Aspect 36: An apparatus comprising a processor; memory coupled with the processor; and instructions stored in the memory and executable by the processor to cause the apparatus to perform a method of any of aspects 23 through 29.

Aspect 37: An apparatus comprising at least one means for performing a method of any of aspects 23 through 29.

Aspect 38: A non-transitory computer-readable medium storing code the code comprising instructions executable by a processor to perform a method of any of aspects 23 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
a processor;
memory coupled with the processor; and
instructions stored in the memory and executable by the processor to cause the apparatus to:
receive, at a first device, one or more frames from a second device, the one or more frames being associated with an Ethernet-type protocol data unit session, wherein a first frame of the one or more frames excludes a virtual local area network tag;
classify each frame of the one or more frames according to a plurality of traffic classes that are each associated with a respective queue, wherein the first frame is classified into a traffic class based at least in part on the first frame excluding the virtual local area network tag; and
transmit, from the first device, the one or more frames based at least in part on the plurality of traffic classes and the respective queues.

2. The apparatus of claim 1, wherein the instructions are further executable by the processor to cause the apparatus to:
determine priority information for frames excluding the virtual local area network tag, wherein the first frame is classified based at least in part on the priority information.

3. The apparatus of claim 2, wherein the priority information comprises a default frame priority for frames excluding the virtual local area network tag, and the instructions are further executable by the processor to cause the apparatus to:
apply the default frame priority to the first frame; and
select the traffic class that corresponds to the default frame priority based at least in part on a mapping table, wherein the first frame is classified into the traffic class based at least in part on the default frame priority.

4. The apparatus of claim 2, wherein the priority information comprises a default traffic class for frames excluding the virtual local area network tag, and wherein the first frame is classified based at least in part on the default traffic class.

5. The apparatus of claim 2, wherein the instructions are further executable by the processor to cause the apparatus to:
receive, from a network entity, signaling indicating the priority information, wherein the priority information is determined based at least in part on the signaling.

6. The apparatus of claim 5, wherein the signaling is received via at least one of a port management information container or a bridge management information container.

7. The apparatus of claim 5, wherein the network entity comprises a session management function, a policy control function, a time-sensitive networking application function, or a time-sensitive communication and time synchronization function.

8. The apparatus of claim 2, wherein the priority information comprises a default frame priority for frames excluding the virtual local area network tag, the default frame priority being preconfigured at the first device, and wherein the first frame is classified based at least in part on the default frame priority and a mapping table.

9. The apparatus of claim 2, wherein the priority information comprises a default traffic class for frames excluding the virtual local area network tag, the default traffic class being preconfigured at the first device, and wherein the first frame is classified based at least in part on the default traffic class.

10. The apparatus of claim 1, wherein the first frame excluding the virtual local area network tag is associated with a generic precision time protocol.

11. The apparatus of claim 1, wherein the first device comprises a user equipment (UE) and the second device is associated with a network entity.

12. The apparatus of claim 1, wherein the first device is associated with a network entity and the second device comprises a user equipment (UE).

13. An apparatus, comprising:
a processor;
memory coupled with the processor; and
instructions stored in the memory and executable by the processor to cause the apparatus to:
receive, at a first device, one or more frames from a network, the one or more frames being associated with an Ethernet-type protocol data unit session, wherein a first frame of the one or more frames excludes a virtual local area network tag;
add, to the first frame, a data tag indicating priority information for the first frame based at least in part on the first frame excluding the virtual local area network tag; and
forward, to a second device, the one or more frames including the first frame and the data tag.

14. The apparatus of claim 13, wherein the instructions are further executable by the processor to cause the apparatus to:
determine the priority information for the first frame based at least in part on the first frame excluding the virtual local area network tag.

15. The apparatus of claim 14, wherein the instructions are further executable by the processor to cause the apparatus to:
receive, from a network entity, signaling indicating the priority information for the first frame, wherein determining the priority information is based at least in part on the signaling.

16. The apparatus of claim 15, wherein the instructions are further executable by the processor to cause the apparatus to:
assign default virtual local area network information to the first frame based at least in part on the signaling and the first frame excluding the virtual local area network tag, wherein the priority information comprises an indication of the default virtual local area network information.

17. The apparatus of claim 16, wherein the default virtual local area network information comprises a virtual local area network identifier value and a priority value, and wherein the data tag is based at least in part on the virtual local area network identifier value and the priority value.

18. The apparatus of claim 15, wherein the signaling is received via at least one of a port management information container or a bridge management information container.

19. The apparatus of claim 13, wherein the data tag comprises a virtual local area network identifier or a frame priority, or both.

20. The apparatus of claim 13, wherein the data tag comprises metadata associated with the first frame, the metadata indicating a priority of the first frame.

21. The apparatus of claim 13, wherein the priority information comprises a default frame priority for frames excluding the virtual local area network tag.

22. The apparatus of claim 13, wherein the first frame excluding the virtual local area network tag is associated with a generic precision time protocol.

23. An apparatus, comprising:
a processor;
memory coupled with the processor; and
instructions stored in the memory and executable by the processor to cause the apparatus to:
receive, at a second device, one or more frames from a first device, wherein a first frame of the one or more frames includes a data tag that indicates priority information for the first frame;
remove the data tag from the first frame;
classify each frame of the one or more frames according to a plurality of traffic classes that are each associated with a respective queue, wherein the first frame is classified into a traffic class based at least in part on the priority information indicated by the data tag; and
transmit, from the second device, the one or more frames based at least in part on the plurality of traffic classes and the respective queues.

24. The apparatus of claim 23, wherein the instructions are further executable by the processor to cause the apparatus to:
receive, from a network entity, signaling comprising information associated with the data tag, wherein the data tag is removed based at least in part on the information associated with the data tag.

25. The apparatus of claim 24, wherein the information associated with the data tag comprises a virtual local area network identifier.

26. The apparatus of claim 23, wherein the data tag comprises a virtual local area network identifier and a default frame priority based at least in part on the priority information.

27. The apparatus of claim 23, wherein the data tag comprises metadata associated with the first frame, wherein the first frame is classified based at least in part on the metadata.

28. The apparatus of claim 23, wherein the priority information comprises a default frame priority, and the instructions are further executable by the processor to cause the apparatus to:
apply the default frame priority to the first frame; and
select the traffic class that corresponds to the default frame priority based at least in part on a mapping table, wherein the first frame is classified into the traffic class based at least in part on the default frame priority.

29. The apparatus of claim 23, wherein the first frame excluding is associated with a generic precision time protocol.

30. A method for wireless communications, comprising:
receiving, at a first device, one or more frames from a second device, the one or more frames being associated with an Ethernet-type protocol data unit session, wherein a first frame of the one or more frames excludes a virtual local area network tag;
classifying each frame of the one or more frames according to a plurality of traffic classes that are each associated with a respective queue, wherein the first frame is classified into a traffic class based at least in part on the first frame excluding the virtual local area network tag; and
transmitting, from the first device, the one or more frames based at least in part on the plurality of traffic classes and the respective queues.
